(19) United States
(12) Patent Application Publication
(10) Pub. No.: US 2006/0284966 A1
(43) Pub. Date: Dec. 21, 2006

(54) Apparatus for disconnecting light scanning unit and image forming apparatus having the same

(75) Inventor: Jae-Myong Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/346,191

(22) Filed: Feb. 3, 2006

(30) Foreign Application Priority Data
Jun. 20, 2005 (KR) 2005-52955

(51) Int. Cl. B41J 2/435

(52) U.S. Cl. 347/224

(57) ABSTRACT

An image forming apparatus has an image forming apparatus body. A developing unit is detachably mounted in the image forming apparatus body and includes an image carrier to form an image. A light scanning unit for scanning a light onto the image carrier of the developing unit is mounted in the image forming apparatus body to form an electrostatic latent image on the image carrier. A driving circuit is electrically connected with the light scanning unit to control the operation of the light scanning unit. A connector selectively disconnects power from the driving circuit to the light scanning unit according to whether the developing unit is mounted or dismounted.

### CROSS-REFERENCE TO RELATED APPLICATIONS

This application claims the benefit under 35 U.S.C. § 119(a) of Korean Patent Application No. 2005-52955, filed on Jun. 20, 2005, the entire contents of which are hereby incorporated by reference.

### BACKGROUND OF THE INVENTION

1. Field of the Invention

The present invention relates to a developing unit and an image forming apparatus having the same. More particularly, the present invention relates to an apparatus for disconnecting power from a light scanning unit when the developing unit is dismounted from the image forming apparatus.

2. Description of the Related Art

Generally, an image forming apparatus such as a laser printer, a copier, a scanner, or a multi-functional device includes a light scanning unit.

The light scanning unit is mounted in the image forming apparatus body and scans light onto an image carrier (such as a photosensitive drum) to form an electrostatic latent image. The light scanning unit emits light from a light diode such as a semiconductor laser diode, and the light emitted from the light diode passes through an optical system including a polygonal rotating mirror to be scanned onto the image carrier.

The light emitted from the light diode is strong enough and focused enough that it may pose a safety issue if it directly contacts a human body, especially, if it contacts the eyes. Therefore, special attention is required to handle the light scanning unit.

To this end, the light emitted from the light scanning unit is blocked so that it does not leak out of the image forming apparatus body. As a door at one side of the body is opened and closed to replace consumable products such as a developing unit and an intermediate transfer medium in the image forming apparatus, a safety switch is provided to stop the operation of the light scanning unit.

In other words, generally, a safety switch is provided, and the safety switch turns on and off in association with the closing and opening of the image forming apparatus body. The safety switch is connected to the light scanning unit and a driving circuit of the light scanning unit.

With this structure, the door is occasionally closed and opened without replacing the consumable products. For example, the door is occasionally opened and closed to replace a developer and or to clear a paper jam. Since power supplied to the light scanning unit is frequently disconnected, the driving circuit may be damaged. Additionally, the safety switch may be damaged due to the frequent opening and closing of door, thereby decreasing the durability of the image forming apparatus. Furthermore, if a damaged safety switch malfunctions, a safety issue may arise.

Accordingly, there is a need for an improved apparatus for controlling the operation of a light scanning unit.

### SUMMARY OF THE INVENTION

An aspect of the present invention is to address at least the above problems and/or disadvantages and to provide at least the advantages described below. Accordingly, an aspect of the present invention is to provide a developing unit with an improved structure which can control the operation of a light scanning unit in association with the replacement of consumable products, and an image forming apparatus employing the same.

In accordance with an exemplary embodiment of the present invention, a developing unit for an image forming apparatus includes a light scanning unit provided in an image forming apparatus body to scan a light onto an image carrier of a developing unit. A driving circuit is electrically connected with the light scanning unit to control the light scanning unit. A first connector is electrically connected with each of the driving circuit and the light scanning unit. The developing unit comprises a housing detachably mounted in the image forming apparatus body. An image carrier is rotatably provided at the housing and a part of the image carrier is exposed. At least one developer cartridge supplies the image carrier with developer. A second connector is provided in the housing and is electrically connected with or disconnected from the first connector as the developing unit is mounted in or dismounted from the image forming apparatus body. Power is selectively supplied from the driving circuit to the light scanning unit as the first and the second connectors are engaged or disengaged.

The first connector may comprise a first terminal electrically connected with the driving circuit and a second terminal electrically connected with the light scanning unit, and the second connector may comprise third and fourth terminals corresponding to each of the first and the second terminals. The third and the fourth terminals may be electrically connected with each other.

In accordance with another exemplary embodiment of the present invention, an image forming apparatus comprises an image forming apparatus body. A developing unit is detachably mounted in the image forming apparatus body, and the developing unit includes an image carrier to form an image. A light scanning unit scans light onto the image carrier to form an electrostatic latent image on the image carrier. A driving circuit is electrically connected with the light scanning unit to control the operation of the light scanning unit. A connector selectively connects or disconnects power from the driving circuit to the light scanning unit according to whether the developing unit is mounted or dismounted.

The connector may comprise a first connector fixed in the image forming apparatus body, and a second connector may be provided in the developing unit to connect with or disconnect from the first connector as the developing unit is mounted in or dismounted from the image forming apparatus body.

The first connector may comprise a first terminal electrically connected with the driving circuit and a second terminal electrically connected with the light scanning unit, and the second connector may comprise third and fourth terminals corresponding to each of the first and the second terminals. The third and the fourth terminals may be electrically connected with each other.

The driving circuit may comprise a circuit board fixed in the image forming apparatus body.

The light scanning unit may be arranged at a lower portion or an upper portion of the developing unit.

The developing unit may comprise a housing with an opening, an image carrier which is exposed through the opening, and a developer cartridge. A plurality of developer cartridges may be provided in the housing to develop different color developers on the image carrier.

In accordance with another exemplary embodiment of the present invention, an image forming apparatus comprises a main body. A developing unit is detachably mounted in the main body, and the developing unit comprises a housing and an image carrier. A light scanning unit scans light onto the image carrier, and a means for selectively disconnecting power to the light scanning unit disconnects or connects power according to whether the developing unit is mounted or dismounted.

The means for selectively disconnecting power to the light scanning unit may comprise a first connector disposed on the main body and a second connector disposed on the developing unit. The second connector may be connected with or disconnected from the first connector as the developing unit is mounted in or dismounted from the image forming apparatus body.

A driving circuit may be provided to control the operation of the light scanning unit.

The first connector may comprise a first terminal in electrical communication with the driving circuit and a second terminal in electrical communication with the light scanning unit.

The second connector may comprise third and fourth terminals corresponding to the first and second terminals. The third and the fourth terminals may be in electrical communication with one another.

The driving circuit may comprise a printed circuit board.

The developing unit may include a developer cartridge for developing an image on the image carrier.

The developing unit may further comprise a plurality of developer cartridges provided in the housing for developing images of different colors on the image carrier.

The light scanning unit may be arranged at a lower portion or an upper portion of the developing unit.

### BRIEF DESCRIPTION OF THE DRAWINGS

The above and other objects, features, and advantages of certain exemplary embodiment s of the present invention will be more apparent from the following description taken in conjunction with the accompanying drawings, in which:

FIG. 1 is a schematic construction view of an image forming apparatus according to an exemplary embodiment of the present invention;

FIG. 2 is a perspective view of a developing unit of the image forming apparatus of FIG. 1;

FIG. 3 is a perspective view of a connector of the image forming apparatus of FIG. 1;

FIG. 4 is a schematic sectional view of the construction of the connector of FIG. 3; and

FIG. 5 is a schematic construction view of an image forming apparatus from which a developing unit is separated.

Throughout the drawings, the same reference numerals will be understood to refer to the same elements, features, and structures.

### DETAILED DESCRIPTION OF EXEMPLARY EMBODIMENT S

The matters defined in the description such as a detailed construction and elements are provided to assist in a comprehensive understanding of the exemplary embodiment s of the invention. Accordingly, those of ordinary skill in the art will recognize that various changes and modifications of the exemplary embodiment s described herein can be made without departing from the scope and spirit of the invention. Also, descriptions of well-known functions and constructions are omitted for clarity and conciseness.

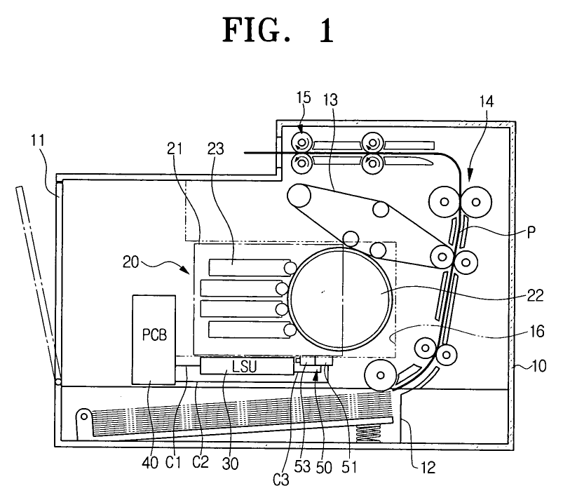

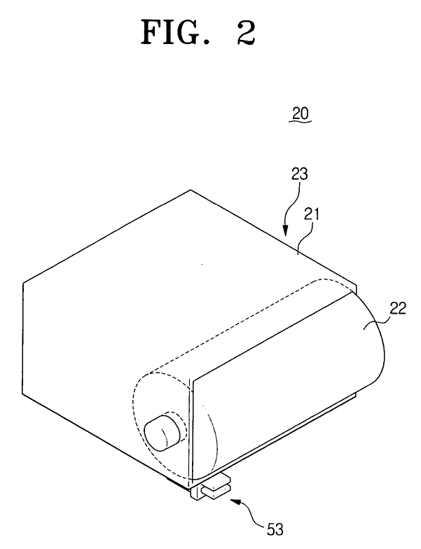

Referring to FIGS. 1 and 2, an image forming apparatus according to an exemplary embodiment of the present invention comprises a main body 10, a developing unit 20 detachably provided in the main body 10, a light scanning unit 30 scanning a light onto an image carrier 22 of the developing unit 20, a driving circuit 40 for controlling the operation of the light scanning unit 30, and a connector 50.

An openable door 11 is provided at one side of the main body 10. When the door 11 is opened, the consumable products such as the developing unit 20 and the intermediate transfer medium 13 in the main body 10 can be replaced.

A medium cassette 12 is provided in a lower portion of the main body 10, and a supply of printing medium may be stacked in the medium cassette 12. The printing medium P supplied from the medium cassette 12 passes the intermediate transfer medium 13 so that an image is transferred to the printing medium P. A fixing unit 14 is provided in the main body 10 to apply heat and pressure to the printing medium P having the transferred image. The printing medium P passing the fixing unit 14 may be discharged to the outside of the main body 10 through the discharge roller 15.

The intermediate transfer medium 13 may be a belt supported by a plurality of rollers to move on an endless loop. The intermediate transfer medium 13 moves in contact with the image carrier 22 of the developing unit 20 in the main body 10 for the image carrier 22 to transfer an image thereto.

As shown in FIG. 2, the developing unit 20 comprises a housing 21 with a side with an opening, an image carrier 22 mounted in the housing 21, and at least one developer cartridge 23 for developing a developer on the image carrier 22.

A mounting part 16 is provided in the main body 10 to detachably mount the developing unit 20.

Since the image forming apparatus in the present exemplary embodiment is a color image forming apparatus, the developer cartridge 23 is provided with a plurality of sequentially arranged developer cartridges to develop color images. A monochrome image forming apparatus may employ a single developer cartridge. In the present exemplary embodiment, developer cartridges 23 for four colors are arranged to sequentially develop cyan, magenta, yellow, and black developers. The developer cartridge 23 with the above construction is a consumable product that may be replaced with a new one as the developer (for example, toner) is consumed. The developing unit 20 is also a consumable product that can be replaced with a new one as the image carrier 22 is consumed. Accordingly, as the image forming apparatus prints on a printing medium over a number of sheets, the door 11 is opened and the developing unit 20 is drawn out of the main body 10 to be replaced with a new developing unit 20.

The light scanning unit 30 is provided in, for example, a lower portion of the developing unit 20. The light scanning unit 30 is controlled by the driving circuit 40 and scans a light onto the image carrier 22 during operation to form an electrostatic latent image on the image carrier 22. The light scanning unit 30 typically comprises components such as a light diode, a polygonal rotating mirror, and a number of optical members, which are well known to those skilled in the art. Therefore, detailed drawings and a description of the light scanning unit 30 is omitted for clarity and conciseness.

The driving circuit 40 is, in an exemplary embodiment, a PCB (printed circuit board). The driving circuit 40 selectively supplies the light scanning unit 30 with external power so as to control the light diode and the polygonal rotating mirror, respectively.

In the present exemplary embodiment, the driving circuit 40 is directly and indirectly electrically connected with the light scanning unit 30. In other words, a first cable C1 directly connects the driving circuit 40 and the light scanning unit 30, and second and third cables C2, C3 connect the driving circuit 40 and the light scanning unit 30 via the connector 50. Accordingly, as the two cables C2, C3 are connected through the connector 50, the light scanning unit 30 can be driven by power supplied from the driving circuit 40.

In contrast, when the two cables C2, C3 are disconnected by the connector 50, power supplied from the driving circuit 40 to the light scanning unit 30 is disconnected so that the light scanning unit 30 does not operate.

The connector 50 comprises a first connector 51 fixed in the main body 10, and a second connector 53 attachable to and detachable from the first connector.

The first connector 51 is provided in the main body 10 to be exposed to the inside of the mounting part 16 where the developing unit 20 is mounted.

The second connector 53 is provided at the developing unit 20, for example, at a lower portion of the housing 21. As the developing unit 20 is mounted in the mounting part 16 of the main body 10, the second connector 53 mounted to the developing unit 20 can be complementarily attached to the first connector 51.

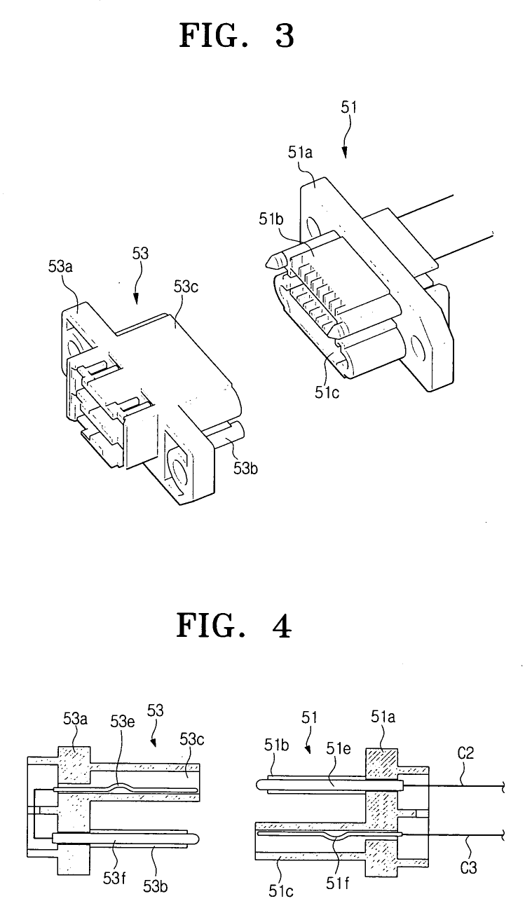

As shown in FIG. 3, the first and the second connectors 51, 53 include connector bodies 51a, 53a, and first connection portions 51b, 53b and second connection portions, 51c, 53c which protrude in a direction of a facing surface of the connector bodies 51a, 53a. The first connection portions 51b, 53b are configured as protrusions, and the second connection portions 51c, 53c are receptacles in which each of the first connection portions 51b, 53b can be inserted. In the illustrated exemplary embodiment, the second connection portions 51c, 53c are hollow, pipe shaped members.

As shown in FIG. 4, the first connector 51 comprises a first and a second terminal 51e, 51f. The first terminal 51e is connected with the second cable C2, and the second terminal 51f is connected with the third cable C3.

The second connector 53 includes third and fourth terminals 53e, 53f which are electrically connected with each other. As the first and the second connectors 51, 53 are connected, the first terminal 51e is electrically connected with the third terminal 53e, and the second terminal 51f is electrically connected with the fourth terminal 53f. Accordingly, as the first and the second connectors 51, 53 are engaged, the second and the third cables C2, C3 are electrically connected so that power can be supplied from the driving circuit 40 to the light scanning unit 30.

The operation of the image forming apparatus with the above structure according to an exemplary embodiment of the present invention will be explained in detail.

Referring to FIG. 1, the developing unit 20 is mounted in the main body 10 and the door 11 is closed. Under this circumstance, the first and the second connectors 51, 53 are engaged, and therefore, the power of the driving circuit 40 can be supplied via the first through third cables C1, C2, C3 to the light scanning unit 30. Accordingly, an image is formed on the image carrier 22 and the formed image is transferred via the intermediate transfer medium 13 onto the printing medium P according to a general developing process. The printing medium P with the transferred image passes the fixing unit 14 and the discharge roller 15 and is discharged to the outside of the main body 10.

As described above, while a printing operation is performed according to a general developing process, the consumable products such as the developing unit 20 and the intermediate transfer medium 13 should be replaced with new ones as they reach the end of their useful lifespans.

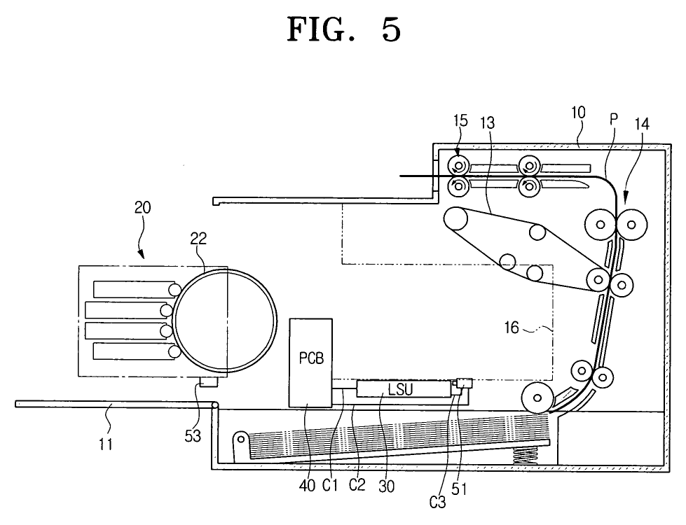

To replace the consumable products, the door 11 is first opened. Then, the developing unit 20 is drawn out of the mounting part 16 of the main body 10 as shown in FIG. 5. At this time, as the developing unit 20 is drawn out of the mounting part 16, the second connector 53 is disengaged from the first connector 51 so that the power supply is cut off to the light scanning unit 30. Accordingly, the operation of the light scanning unit 30 is automatically turned off. Since the driving of the light scanning unit 30 is automatically turned off as the developing unit 20 is drawn out of the main body 10, safety incidents caused by light emitted from the light diode as the developing unit 20 is drawn out of the main body 10 to replace the consumable products can be prevented.

As described above, the developing unit 20 is first drawn out of the main body 10 to replace the developing unit 20 with the new one. Additionally, the developing unit 20 should be disengaged from the main body 10 to replace the intermediate transfer medium 13. Accordingly, as the developing unit 20 is first disengaged from the main body 10 to replace another consumable product, that is, the intermediate transfer medium 13, the operation of the light scanning unit 30 is also automatically turned off.

As new consumable products are mounted in the main body 10 and the door is closed, the first and the second connectors 51, 53 are electrically connected as shown in FIG. 1 so that the light scanning unit 30 can be driven.

As described above, the first and the second connectors 51, 53 are separated so that the driving of the light scanning unit 30 is off when the developing unit 20 is disengaged from the main body 10 to replace the consumable products. In other words, the power supply is not cut off to the light scanning unit 30 by the operation of opening of the door 11 to, for example, clear paper jams or to check conditions inside the main body 10. Therefore, the light scanning unit 30 is not subjected to frequent off operations. Accordingly, the durability of the driving circuit to control the light scanning unit 30 can be enhanced.

The first and the second connectors 51 and 53 are also disengaged when replacing the developing unit 20 or the intermediate transfer medium 13 with new ones, after they are engaged with each other when the developing unit 20 is mounted in the main body 10. Therefore, the two connectors 51, 53 are not frequently engaged and disengaged. Accordingly, the degradation of the connection between the two connectors 51, 53 is prevented so that the durability can be improved and the stable connection can be maintained.

FIGS. 1 through 5 show that the first and the second connectors 51, 53 have substantially the same height as the light scanning unit 30. However, the connector 50 and the light scanning unit 30 may be arranged along the lengthwise direction of the image carrier 22 so that the second connector 53 does not interfere with the light scanning unit 30 as the developing unit 20 moves.

As described above, in a developing unit and image forming apparatus using the same in accordance with an exemplary embodiment of the present invention, the power can be supplied to the light scanning unit by using connectors. The connectors are disconnected when the developing unit is separated from the main body to replace consumable products such as the developing unit and the intermediate transfer medium. Therefore, the light scanning unit can be turned on and off only to replace consumable products so that frequent on and off operations of the light scanning unit can be prevented.

Accordingly, stress or overload based on the frequent on and off operations of the driving circuit of the light scanning unit can be minimized, and therefore, the durability of the driving circuit can be enhanced. Additionally, the occasional engagements and disengagements between connectors (which disconnect the power supply) are minimized so that damage to the connectors is minimized.

While the invention has been shown and described with reference to certain exemplary embodiment s thereof, it will be understood by those skilled in the art that various changes in form and details may be made therein without departing from the spirit and scope of the invention as defined by the appended claims.

What is claimed is:

1. An image forming apparatus, comprising:
an image forming apparatus body;
a developing unit detachably mounted in the image forming apparatus body, the developing unit comprising an image carrier for forming an image;
a light scanning unit for scanning a light onto the image carrier to form an electrostatic latent image on the image carrier;
a driving circuit electrically connected with the light scanning unit to control operation of the light scanning unit;
a connector for selectively disconnecting power from the driving circuit to the light scanning unit according to whether the developing unit is mounted or dismounted.

2. The apparatus according to claim 1, wherein the connector comprises:
a first connector fixed in the image forming apparatus body; and
a second connector provided in the developing unit to connect with or disconnect from the first connector as the developing unit is mounted in or dismounted from the image forming apparatus body.

3. The apparatus according to claim 2, wherein
the first connector comprises a first terminal electrically connected with the driving circuit and a second terminal electrically connected with the light scanning unit.

4. The apparatus according to claim 3, wherein
the second connector comprises third and fourth terminals corresponding to the first and second terminals, respectively, and the third and the fourth terminals are electrically connected with each other.

5. The apparatus according to claim 1, wherein
the driving circuit comprises a circuit board fixed in the image forming apparatus body.

6. The apparatus according to claim 1, wherein
the light scanning unit is arranged at a lower portion or an upper portion of the developing unit.

7. The apparatus according to claim 1, wherein the developing unit further comprises:
a housing with an opening, a part of the image carrier being exposed to the opening in the housing; and
a developer cartridge provided in the housing to develop a developer onto the image carrier.

8. The apparatus according to claim 1, wherein the developing unit further comprises:
a plurality of developer cartridges provided in the housing to develop images of at least two colors.

9. A developing unit for an image forming apparatus including a light scanning unit provided in an image forming apparatus body to scan a light onto an image carrier of a developing unit, a driving circuit electrically connected with the light scanning unit to control the operation of the light scanning unit, and a first connector electrically connected with each of the driving circuit and the light scanning unit, the developing unit comprising:
a housing detachably mounted in the image forming apparatus body;
an image carrier rotatably disposed in the housing;
at least one developer cartridge supplying the image carrier with developer; and
a second connector provided in the housing, the second connector being electrically connected with or disconnected from the first connector as the developing unit is mounted in or dismounted from the image forming apparatus body; whereby power is selectively supplied from the driving circuit to the light scanning unit as the first and the second connectors are engaged or disengaged.

10. The developing unit according to claim 9, wherein
the first connector comprises a first terminal electrically connected with the driving circuit and a second terminal electrically connected with the light scanning unit.

11. The developing unit according to claim 10, wherein
the second connector comprises third and fourth terminals corresponding to the first and second terminals, respectively, and the third and the fourth terminals are electrically connected with each other.

12. An image forming apparatus, comprising:
a main body;
a developing unit detachably mounted in the main body, the developing unit comprising a housing and an image carrier;
a light scanning unit for scanning light onto the image carrier;
means for selectively disconnecting power to the light scanning unit according to whether the developing unit is mounted or dismounted.

13. The apparatus according to claim 12, wherein the means for selectively disconnecting power to the light scanning unit comprises:
a first connector disposed on the main body; and
a second connector disposed on the developing unit, the second connector being connected with or disconnected from the first connector as the developing unit is mounted in or dismounted from the image forming apparatus body.

14. The apparatus according to claim 13, further comprising
a driving circuit for controlling operation of the light scanning unit.

15. The apparatus according to claim 14, wherein
the first connector comprises a first terminal in electrical communication with the driving circuit and a second terminal in electrical communication with the light scanning unit.

16. The apparatus according to claim 15, wherein
the second connector comprises third and fourth terminals corresponding to the first and second terminals, respectively.

17. The apparatus according to claim 16, wherein
the third and the fourth terminals are in electrical communication with one another.

18. The apparatus according to claim 13, wherein
the driving circuit comprises a printed circuit board.

19. The apparatus according to claim 12, wherein the developing unit further comprises:
a developer cartridge for developing an image on the image carrier.

20. The apparatus according to claim 12, wherein the developing unit further comprises:
a plurality of developer cartridges provided in the housing for developing images of at least two colors on the image carrier.
